(19) United States
(12) Patent Application Publication
(10) Pub. No.: US 2002/0098865 A1
(43) Pub. Date: Jul. 25, 2002

(54) Method and system to transition from a facsimile communications session to a voice communications session

(75) Inventors: Ke-Chi Jang, Plano (TW); Chung-Ching Wang, Plano (TW)

Correspondence Address: HAYNES AND BOONE, LLP, 901 MAIN STREET, SUITE 3100, DALLAS, TX, 75202, US

(73) Assignee: Nortel Networks Limited, St. Laurent (CA)

(21) Appl. No.: 09/999,366

(22) Filed: Nov. 15, 2001

Related U.S. Application Data
(60) Provisional application No. 60/251,273, filed on Dec. 4, 2000.

(51) Int. Cl. H04Q 7/20

(52) U.S. Cl. 455/557; 455/403; 455/560

(57) ABSTRACT

Disclosed is a method of transitioning from a facsimile session to a voice session during a call between a wireless user and a facsimile machine. The method comprises sending a procedure interrupt request, sending a procedure interrupt response, sending a procedure interrupt confirmation, negotiating to a voice service option, and then beginning the voice service option.

### CROSS-REFERENCE

This invention claims the benefit of U.S. Provisional Patent Application Ser. No. 60/251,273 filed on Dec. 4, 2000.

### TECHNICAL FIELD

The invention relates in general to mobile phone networks, and in particular to communicating with facsimile equipment using mobile phones over a Code Division Multiple Access (“CDMA”) CDMA network.

### BACKGROUND INFORMATION

Mobile phone users are increasingly relying on wireless networks to meet both their personal and business needs. Such needs often include data services in addition to voice communication. To employ data services, many service providers have chosen CDMA technology. CDMA is a “spread spectrum” technology, which means that it spreads the information contained in a particular signal of interest over a much greater bandwidth than the original signal.

One data service that is gaining wide acceptance is the ability to send and receive facsimiles or faxes over wireless networks. As is well known, a Facsimile or “Fax” machine allows a paper document to be sent through a switched telephone system and printed out elsewhere. Facsimile equipment or fax machines can be considered to be a node in a communications network, such as a pubic switch telephone network (“PSTN”). Such facsimile equipment may be a traditional fax machine, which includes a scanner and a printer. Such facsimile equipment could also in a fax modem coupled to a computer application which emulates a traditional fax machine (i.e., a “fax application”). For purposes of this application, a “fax terminal” is defined to include all forms of facsimile equipment and fax machines.

There are six internationally accepted specifications for fax terminals: Group 1, Group 2, Group 3, Group 3 Enhanced, Super GE, and Group 4. Most fax terminals sold today operate according to the Group 3 or Group 3 Enhanced specification and have transmission speeds of 9,600 bps to 14,400 bps.

After sending a fax over a CDMA network, many users would like the ability to transition to a voice call so that they can verbally check on the status of the call, be transferred to another phone, or perform another operation without having to make a separate call. Currently, a digital-fax to voice transition in a single call is not supported with CDMA technology. If a user would like to resume or start a voice conversation after sending a fax, the user must disconnect and place another call.

What is needed, therefore, is a system or method that allows a transition from fax operation to voice operation within a single call.

### SUMMARY OF THE INVENTION

The previously mentioned needs are fulfilled with the present invention. Accordingly, there is provided, a method of transitioning from a facsimile session to a voice session during a call between a wireless user and a fax terminal. In one embodiment, the method comprises generating a request at a first terminal to transition from a fax transmission mode to a voice transmission mode, transmitting the request from the first terminal to a second terminal, transmitting a response from the second terminal to indicate the second terminal accepts the request to transition from fax to voice transmission mode; and transmitting an authorization from the first terminal to the second terminal to cause the first terminal and the second terminal to change from fax to voice transmission mode.

These and other features, and advantages, will be more clearly understood from the following detailed description taken in conjunction with the accompanying drawings. It is important to note the drawings are intended to represent only an exemplary form of the present invention.

### BRIEF DESCRIPTION OF THE DRAWINGS

FIG. 1 is an exemplary system incorporating one embodiment of the present invention.

FIG. 2 is a call flow diagram illustrating a general method of transitioning from a Fax communications mode to a voice communications mode within the same call session.

FIG. 3 is a detail call flow diagram illustrating a method of transitioning from a fax communications mode to a voice communications mode when a mobile unit is sending a fax to a fax terminal and a user of the mobile unit initiates the transition.

FIG. 4 is a detail call flow diagram illustrating a method of transitioning from a fax communications mode to a voice communications mode when a mobile unit is sending a fax to a fax terminal and a user of the fax terminal initiates the transition.

FIG. 5 is a detail call flow diagram illustrating a method of transitioning from a fax communications mode to a voice communications mode when a fax terminal is sending a fax to a mobile unit and a user of the mobile unit initiates the transition.

FIG. 6 is a detail call flow diagram illustrating a method of transitioning from a fax communications mode to a voice communications mode when a fax terminal is sending a fax to a mobile unit and a user of the fax terminal initiates the transition.

### DETAILED DESCRIPTION

Definitions and Terms:

The following terms are used throughout this application:

IS-2000—refers to the Telecommunications Industry Association's (TIA) family of standards which includes core air interface, minimum performance, and service standards. The air interface standards specify a spread spectrum radio interface that uses Code Division Multiple Access (CDMA) technology to meet the requirements for Third Generation (3G) wireless communication systems.

IS-707-A.3 refers to the TIA's standard entitled IS-707-A.3, “Data Service Options for Spread Spectrum Systems:AT Command Processing and the Rm Interface.” This standard provides requirements for the Rm Interface, Service Selection methods, and AT Command processing required for mobile stations and Base Stations. IS-707-A.3 also includes Service Class 2.0 AT commands from TIA/EIA-592-A that may be required by some components of the system.

IS-707-A.4—refers to the TIA's standard entitled IS-707-A.4, “Data Service Options for Spread Spectrum Systems:Async Data and Fax Services,” which defines protocols and procedures that are used to provide asynchronous data transmission (including Group-3 facsimile) capability on IS-95-A (and also IS-2000). Protocols in the IS-707-A.4 standard define the upper layers (Application Layer, Transport Layer, Network Layer and Link Layer) requirements and radio interface requirements such as service option negotiation.

IS-95—refers to the TIA's standard entitled TIA/EIA/IS-95-A, “Mobile Station-Base Station compatibility Standard for Dual-Mode Wideband Spread Spectrum Cellular System.” This is the digital CDMA standard for U.S. cellular radio systems.

TIA-EIA-592-A—refers to the TIA's standard entitled TIA-EIA-592-A, “Asynchronous Facsimile DCE Control Standard-Service Class 2.” This standard contains protocols for use between data terminal equipment and a fax terminal. This standard also defines the commands that the data terminal equipment may issue to configure and control the facsimile session, and the responses the fax terminal issues to those commands.

T.30—refers to the International Telecommunication Union's (“ITU”) Recommendation T.30 “Procedures for Document Facsimile Transmission in the General Switched Telephone Network.” This recommendation defines procedures used by Group 3 fax terminals to enable documents to be transmitted on general switched telephone networks.

Description:

The principles of the present invention and their advantages are best understood by referring to the illustrated embodiment depicted in FIGS. 1-6 of the drawings, in which like numbers designate like parts or sequences. In the following description, well-known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art.

Referring to FIG. 1, ah exemplary wireless communications system and network 100 is shown for implementing various embodiments of the present invention. For the sake of example, the network/system 100 utilizes CDMA modulation techniques based on the IS-95 or IS-2000 standards. It should be apparent to one of ordinary skill in the art that the present invention can be equally applicable to similar wireless communication systems employing other CDMA techniques (e.g., ones based on the ANSI J 008 standard) or those employing other types of multiple access techniques that use service negotiations.

A data or fax application may reside on a mobile terminal equipment (“TE2”) 102, which may be a laptop computer, a handheld computer, or some other portable device. A data-capable mobile station or mobile terminal (“MT2”) 104 is coupled to the TE2 102. The MT2 104 may be a mobile phone, a radio modem or some other wireless device. If the TE2 102 is a laptop computer, the TE2 102 may be coupled to the MT2 104 by means of any conventional interface, such as an RS-232 serial interface, a USB interface, or a IEEE 802.11 wireless interface. In some embodiments, the TE2 102 and the MT2 104 may be located in a single housing, such as in a wireless enabled handheld computer. Communications Path 106 represents the communications interface between the MT2 104 and the TE2 102.

The MT2 104 communicates via radio waves to a Base Transceiver Station (“BTS”) coupled to a Base Station Controller (“BSC”) 108. A Mobile Switching Center (“MSC”) or MSC 116 is typically coupled to a multitude of BSCs. The MSC 116 includes interface and processing circuitry for providing system control to the various BSCs which are coupled to the MSC 116 (only BSC 108 is illustrated in FIG. 1). The MSC 116 also controls the routing of telephone calls, such as from a public switched telephone network (PSTN) 118 to the mobile phones, and vice versa. Radio waves transfer data over communications link 110 utilizing IS-95 or IS-2000 traffic protocols and frames between the MT2 104 and the BTS (not shown).

Also coupled to the MSC 116 is an Inter-Working Function 114 (“IWF”). In some embodiments, the IWF 114 is located, or anchored, at the MSC 116. The primary function of the IWF 114 is to act as a data signal converter between the fixed network PSTN 118 and the mobility network (i.e., the MSC 116, the BSC 108, and any other BSCs coupled to the MSC 116), providing circuit-mode data access for mobile users in the mobility network. The IWF 114 is typically implemented as a V-series modem pool, which is responsible for signal adaptation and modulation/demodulation between the PSTN-based application data and the MSC 116. Whenever circuit data is requested, the MT2 104 sends modem commands to the IWF 114, which then configures a modem in the modem pool for the specified data service type. As is known in the art, the combination of the MT2 104, the BSC's Selection/Distribution unit 109, and the IWF 114 emulates a standard telephone modem used for dial up connections to a PSTN.

A mobile data path 112 couples the BSC 108 to the IWF 114. The interface connecting the IWF 114 and the MSC 116 is referred to in the art as the “L-interface.” The L-interface comprises three parts, the mobile data path 112, a signaling path 120, and a PSTN path 122. The mobile data path 112 is used to transfer digital data to the IWF 114. The signaling path 120 carries control signal data between the IWF 114 and the MSC 116, allowing the MSC 116 to control the IWF 114. The PSTN path 122 carries the modulated modem signals to and from the PSTN 118.

An exemplary fax terminal 124 is shown coupled to the PSTN 118. The fax terminal 124 may include an interface that uses analog modem tones (compliant with ITU Recommendations V.17 or V.29) and is designed to allow the fax terminal to communicate over the PSTN 118. The messaging protocol used to exchange documents follows the T.30 standards set, which is incorporated by reference in its entirety. Collectively, the fax terminals following the T.30 standards are Group III (G3) fax terminals. These G3 fax terminals are analog fax terminals in contrast to fax terminals or computers which emulate fax machines which communicate over a digital medium. For example, one common digital messaging format is known as Class 2.0. In particular, data devices such as laptop and desktop personal computers often implement Class 2.0 messaging formats for the communications through wireless transceivers.

For the fax terminal 124 to establish a fax communications with the TE2 102, a communications link is established through the PSTN 118 and the PSTN path 122 to the IWF 114. From the IWF 114, a communications path is then established using the mobile data path 112 to the BSC 108, which in turn sends the communication signal to the BST for radio transmission to the MT2 104 via communications link 110. The MT2 104 sends the communications to the TE2 102 using the communications path 106. Thus, any data transmission from the fax terminal 124 to the TE2 102 travels through numerous components and systems, including the PSTN 118, the IWF 114, the BSC 108, and the MT2 104.

There are a multitude of different protocols and standards which are used by the various legs of the communications link. For example, T.30 may be used for fax transmissions between the fax terminal 124 and the PSTN 118. The T.30 standard may also used for fax transmissions between the IWF 114 and the PSTN 118. The voice standard between the MT2 104 and the BTS (not shown) is IS-95 (or IS-2000). The IS-707-A.4, on the other hand, is used for fax transmissions between the BSC 108 and the IWF 114. Thus, any signal between the fax terminal 124 and the MT2 104 is translated to different standards and protocols as the signal moves from component to component.

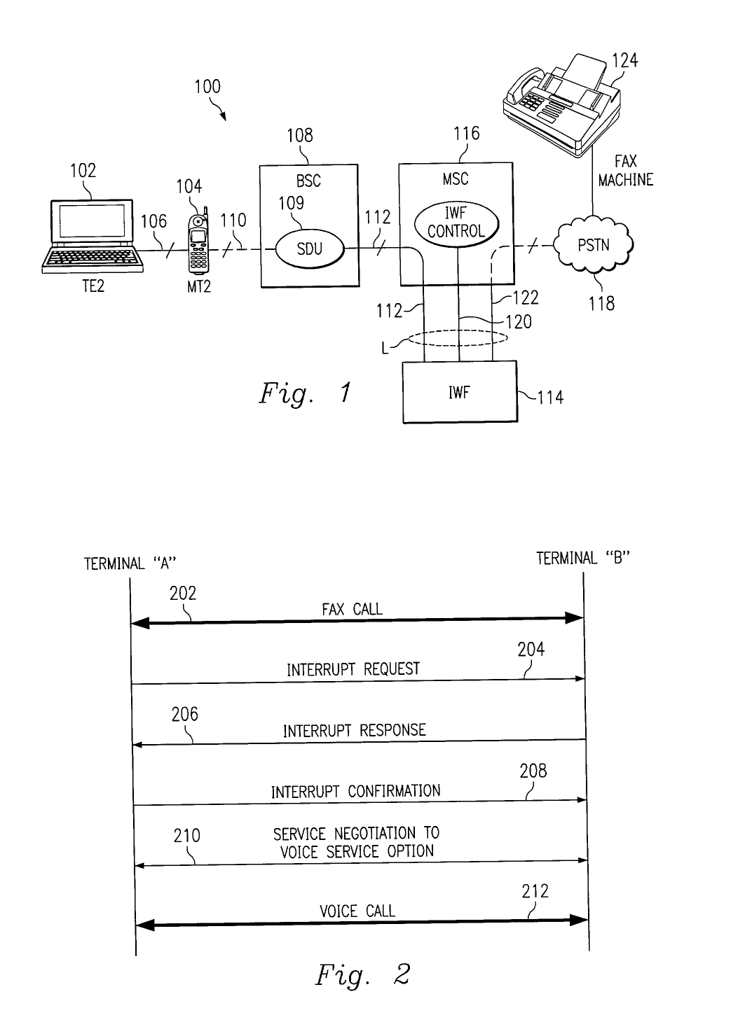

Turning now to FIG. 2, there is a sequence call flow diagram illustrating the general process of transitioning from a fax session to a voice session between two terminals. A facsimile session may be viewed as a signal fax connection from the beginning of the transmission to the end of the transmission and is represented by arrow or step 202. Thus, in step 202, a fax session is ongoing between a terminal “A” and a terminal “B.” The terminal “A” could be either the TE2 102 or the fax terminal 124. Similarly, the terminal “B” could also be either the TE2 102 or the fax terminal 124.

It is desired to continue the call after the fax session is complete. Thus, a user of the terminal “A” may signal the terminal to transition to a voice mode. In this illustrative scenario, the user may be a human or an application program. If the user is a human, the user could use a number of conventional methods, such as pressing a particular sequence of keys or buttons, to indicate to the application program or terminal “A” that the user wishes to transition from the fax session to a voice session.

In response to the user's indication, in step 204, the terminal “A” generates and sends a request to transition from fax to voice. In some embodiments, this request is in the form of an interrupt request to terminal “B”. When the terminal “B” receives the request, it sends a response back to terminal “A” (step 206). The response could be in the form of an interrupt response signal. Having received the response, in step 208, the terminal “A” sends an authorization in the form of an interrupt confirmation signal back to the terminal “B” which confirms the transition request. Terminal “B” then transitions to a phone coupled to the terminal. In step 210, a conventional service negotiation is then performed to transition to a voice service option over the system. In step 212, the voice call begins between the phones coupled to the respective terminals.

The steps discussed above (such as the interrupt request 204) may involve a series of signals transmitted across the various legs of the communications link between the two terminals. The signals are converted by the MT2 104, the BSC 108, and the IWF 114 into a variety of formats (which are dictated by various standards and protocols) as they travel along the various legs of the communication link.

Thus, particular signals may be used to accomplish the general method of transitioning from a fax session to a voice session as represented in FIG. 2. However, these signals will vary depending on which user (i.e., the user of the MT2 104 or the user of the fax terminal 124) initiated the transition and whether the terminal is sending or receiving the facsimile. The various combinations will result in four scenarios:

Scenario 1-the mobile unit is sending a fax transmission to the fax terminal and the user of the user of the mobile unit initiates the transition.

Scenario 2-the mobile unit is sending a fax transmission to the fax terminal and the user of the fax terminal initiates the transition.

Scenario 3-the fax terminal is sending a fax transmission to the mobile unit and the user of the mobile unit initiates the transition.

Scenario 4-the fax terminal is sending a fax transmission to the mobile unit and the user of the fax terminal initiates the transition.

The following discusses each scenario of the general method illustrated in FIG. 2.

Scenario 1:

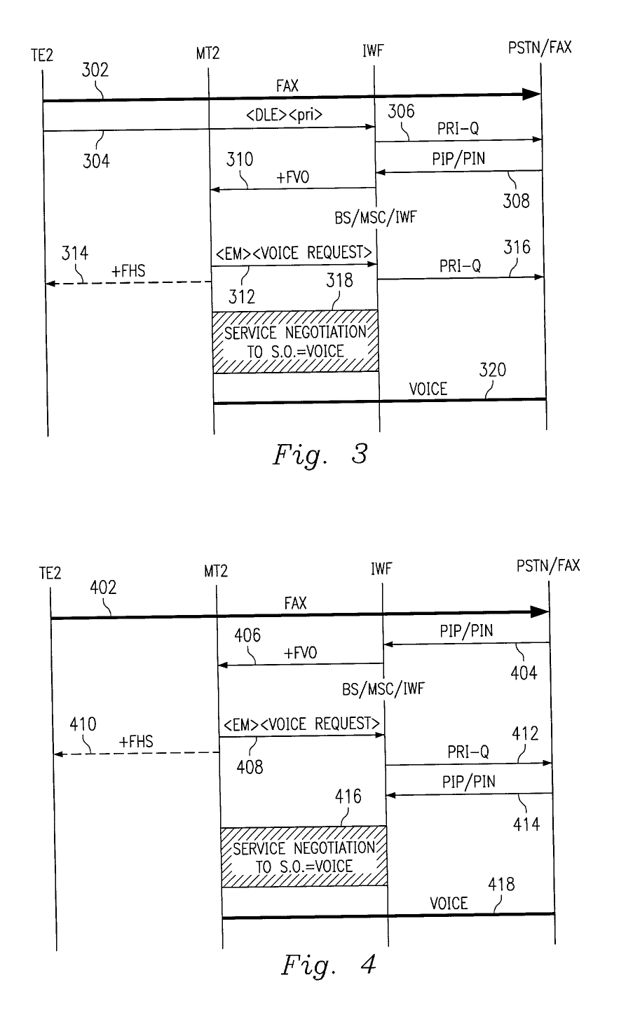

Turning now to FIG. 3, there is a detailed call flow diagram illustrating the method of transitioning from a fax session to a voice session. In step 302, the TE2 102 is in the process of sending a fax transmission to the fax terminal 124 which is coupled to the PSTN 118. After the user of the TE2 102 indicates he wants to transition, in step 304, the application program will then direct the TE2 102 to send a Request Procedure Interrupt signal in the form of a “<DLE><pri>” command to the IWF 114 to initiate or request a procedure interrupt. The “<DLE><pri>” command is formally defined in TIA/EIA-592-A and TIA/EIA/IS-707-A.3, which are incorporated by reference in their entirety. Upon receiving the <DLE><pri> command from TE2 102, the IWF 114 in step 306 sends a Procedure Interrupt Request in the form of a “PRI-Q” command to the PSTN/Fax to request voice call. The PRI-Q command is a general Procedure Interrupt term defined in the ITU-T T.30 specification and refers to either PRI-EOM (End Of Message), PRI-MPS (MultiPage signal) or a PRI-EOP (End Of Procedures) post message command. The T.30 specification is also incorporated by reference in its entirety. These messages are generated when the operator intervention is needed. Beside intervention requests, these messages tells the status of transmission at the time of intervention. The PRI-EOM command is used to indicate the end of a complete page of facsimile information. The PRI-MPS command is used to indicate the end of a complete page of facsimile information and there are more pages to follow. The PRI-EOP command is used to indicate the end of a complete page of facsimile information and to further indicate that no further documents are forthcoming.

Upon receiving the PRI-Q command, the fax terminal 124 notifies its user (e.g. by ringing or beeping) to indicate the voice request from mobile station. If the fax user accepts the voice call request, i.e. by picking up the handset, in step 308, the fax terminal 124 sends a Procedure Interrupt Response signal to the IWF 114. The Procedure Interrupt Response signal will be either a PIP or a PIN command and, will be referred to as the “PIP/PIN” command. The PIP command is the positive response to PRI-Q command, and PIN is the negative response to this message. The PIP command may be used to indicate that a PRI-Q has been received but that further transmissions are not possible without operator intervention. On the other hand, the PIN command is used to indicate that the previous (or in progress) PRI-Q command has not been satisfactorily received and that further transmissions are not possible without operator intervention. Both commands of these commands are defined in the ITU-T T.30 specification.

After receipt of either the PIP/PIN command, in step 310 the IWF 114 notifies the MT2 104 by sending a Transition to Voice signal, which may be in the form of a +FVO command. In the illustrative embodiment the +FVO command is used to indicate that remote facsimile has accepted the request. The +FVO command is defined in TIA/EIA-592-A. Upon receiving this command, the fax session will be suspended and wait for further instruction from operator or application. As a result, the mobile user may hear ringing or beeping.

If mobile user answers the call, in step 312 the MT2 104 sends a cellular voice request in the form of a <EM><Voice Request> signal to the IWF 114. The <EM><Voice Request> is a cellular extension command which lets the IWF 114 know that the mobile user has accepted the fax to voice transition. The <EM><Voice Request> command is defined in TIA/EIA/IS-707-A.3. In step 314, the MT2 104 may also send a +FHS command to the TE2 102 to terminate the fax operation. A +FHS command is Call Termination Status command defined in TIA/EIA-592-A. Upon receiving the <EM><Voice Request> signal, in step 316, the IWF 114 sends a Procedure Interrupt Confirmation signal in the form of another PRI-Q command to reconfirm the initial interrupt request. The MT2 104 together with the BSC 108 then initiates a conventional voice service negotiation in step 318. Upon completion of service negotiation, the communications path no longer travels through the IWF 114, but is routed through the MSC over voice paths to allow both sides to start the voice session in step 320.

Scenario 2:

Turning now to FIG. 4, there is a detailed call flow diagram illustrating the method of transition from a fax session to a voice session between the TE2 102 and the fax terminal 124 during another scenario. In this scenario, the TE2 102 is again in the process of sending a fax transmission to the fax terminal 124 (step 402), but a user of the fax terminal 124 initiates the transition from fax to voice.

After the user initiates the transition, in step 404, the fax terminal 124 sends a Procedure Interrupt Request in the form of a PIP/PIN signal to the IWF 114 to request a Procedure Interrupt. Upon receiving the PIP/PIN command from the fax terminal 124, in step 406 the IWF 114 sends a Transition to Voice signal in the form of a +FVO signal to the MT2 104 to indicate that the fax terminal 124 is requesting a procedure interrupt.

If the mobile user accepts the procedure interrupt (e.g. presses talk function on a mobile phone), in step 408 the MT2 104 sends the cellular voice request signal in the form of a <EM><Voice Request> to the IWF 114 indicating that the MT2 104 will accept the fax to voice transition. The MT2 104 may also send terminate fax command (e.g., +FHS) to the TE2 102 to terminate the fax operation (step 410). Upon receiving the <EM><Voice Request> command, the IWF 114 sends a Procedure Interrupt Response in the form of an appropriate PRI-Q signal to the fax terminal 124 (step 412).

Upon receiving the PRI-Q command from the IWF 114, if the fax user takes some action to answer the call (i.e. removes the phone off of the hook), in step 414 the fax terminal 124 then sends a Procedure Interrupt Confirmation signal by resending the PIP/PIN signal to reconfirm the voice request and to have the line ready for voice call. Upon receiving the Procedure Interrupt Confirmation signal from fax terminal 124, in step 416, the MT2 104 together with the BSC 108 then initiates a conventional voice service negotiation. Upon completion of service negotiation, the communications path no longer travels through the IWF 114, but is routed through the MSC in a conventional manner to allow both sides to start the voice conversation in step 418.

Scenario 3:

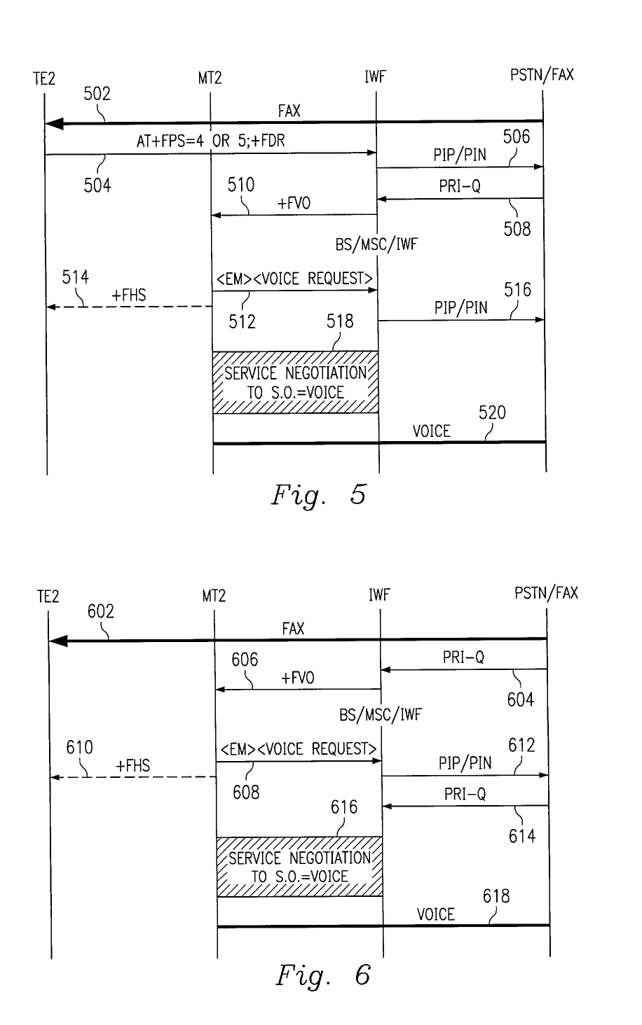

Turning now to FIG. 5, there is a detailed call flow diagram illustrating the method of transition between the TE2 102 and the fax terminal 124 during another scenario. In this illustrative scenario, the fax terminal 124 is in the process of sending a fax transmission to the TE2 102 (step 502) and user of the TE2 102 initiates the transition from a fax session to a voice session.

In response to the user command to initiate the transition, in step 504, the TE2 102 sends a Request Procedure Interrupt in the form of a command sequence: AT+FPS=?;+FDR to initiate the Procedure Interrupt. The FPS or “Page Transfer Status” message value can be either 4 or 5 depending on whether the PIP or the PIN command is issued. The FPS value “4” corresponds to the PIP command. The FPS value “5” corresponds to the PIN command. The FPS message contains a value representing a post page response, including copy quality and related end-of-page status. Thus, the receiving (remote) station can use this message to request a Procedure Interrupt. For instance, the TE2 102 could use the Post Page Response Messages Code 4 associated with +FPS parameter to represent the PIN command (e.g., page bad; interrupt requested). Alternatively, the TE2 102 could also use a Code 5 to represent a PIP command (e.g., page good; interrupt requested). Upon receiving the +FPS command, the IWF 114 issues either a PIP or PIN command.

The last command in the command string is the “+FDR” or “Receive a Page” command. The TE2 102 can use a code stored in the +FPS parameter to determine the Post Page response to the remote fax terminal. The TE2 102 may then issue a +FDR to release the Post Page Message. Both the FPS and the FDR commands are formally defined in the TIA/EIA-592-A.

Upon receiving the Request Procedure Interrupt from the TE2 102, in step 506 the IWF 114 sends a Procedure Interrupt Request in the form of a PIP/PIN signal to the fax terminal 124 to request the Procedure Interrupt. Upon receiving the PIP/PIN command, the fax terminal 124 notifies its user (e.g. by ringing) that the mobile station is requesting a Procedure Interrupt. If the fax terminal user accepts the interrupt request, (i.e. by picking up the handset), in step 508 the fax terminal 124 sends a Procedure Interrupt Response in the form of a PRI-Q command to the IWF 114 indicating acceptance of the transition. Upon receiving the PRI-Q command, in step 510 the IWF 114 sends a Transition to Voice signal in the form of a +FVO command to the MT2 104 (the mobile user may hear ringing or beeping) to indicate that remote facsimile has accepted the transition request.

If mobile station answers the call, in step 512 the MT2 104 sends the Cellular Voice Request signal, <EM><Voice Request> to the IWF 114. The MT2 104 may also send a +FHS command to the TE2 102 to terminate the fax operation (step 514). Upon receiving the <EM><Voice Request> command, in step 516 the IWF 114 sends a Procedure Interrupt Confirmation signal by resending a PIP/PIN command to reconfirm the initial interrupt request (performed at step 506). The MT2 104 together with the BSC 108 then initiates a conventional voice service negotiation in step 518. Upon completion of service negotiation, the communications path no longer travels through the IWF 114, but is routed through the MSC in a conventional manner to allow both sides to start the voice session in step 520.

Scenario 4:

Turning now to FIG. 6, there is a detailed call flow diagram illustrating the method of transition between the TE2 102 and the fax terminal 124 during yet another scenario. In this scenario, the fax terminal 124 is in the process of sending a fax transmission to the TE2 102 and a user of the fax terminal 124 initiates the transition from a fax session to a voice session.

In response to the user's command to transition, in step 604, the fax terminal 124 sends a Procedure Interrupt Request as a PRI-Q command to the IWF 114 to request a Procedure Interrupt. Upon receiving the PRI-Q command from the fax terminal 124, in step 606 the IWF 114 sends a Transition to Voice signal (e.g., a +FVO command) to the MT2 104 to indicate that the fax terminal 124 is requesting a Procedure Interrupt.

If the mobile user accepts the interrupt (e.g. presses talk function on a mobile phone), in step 608 the MT2 104 sends the Cellular Voice Request signal in the form of an <EM><Voice Request> signal to the IWF 114 indicating that the MT2 104 will accept the fax to voice transition. The MT2 104 may also send terminate fax command (e.g., +FHS) to the TE2 102 to terminate the fax operation (step 610). In step 612, upon receiving the <EM><Voice Request> command, the IWF 114 sends a Procedure Interrupt Response in the form of an appropriate PIP/PIN command to the fax terminal 124, which notifies the fax terminal of the mobile user acceptance of the transition.

Upon receiving the PIP/PIN command from the IWF 114, if the fax user takes some action to answer the call (i.e. removes the phone off of the hook), in step 614 the fax terminal 124 then sends a Procedure Interrupt Confirmation signal by resending the PRI-Q command to reconfirm the voice request and have the line ready for voice call (step 614). Upon receiving the confirmation (e.g., the PRI-Q command) from fax terminal 124, in step 616, the MT2 104 together with the BSC 108 then initiates a conventional voice service negotiation. Upon completion of service negotiation, the communications path no longer travels through the IWF 114, but is routed through the MSC in a conventional manner to allow both sides to start the voice conversation in step 618.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It is therefore, contemplated that the claims will cover any such modifications or embodiments that fall within the true scope of the invention.

What is claimed is:

1. A method to transition from a fax transmission mode to a voice transmission mode between a first terminal and a second terminal, one of the terminals being a wireless terminal, the method comprising:
transmitting a request from the first terminal to the second terminal to transition from a fax transmission mode to a voice transmission mode;
transmitting a response from the second terminal to the first terminal to indicate the second terminal accepts the request to transition from fax to voice transmission mode; and
transmitting an authorization from the first terminal to the second terminal to cause the first terminal and the second terminal to change from fax to voice transmission mode.

2. The method of claim 1 wherein the both terminals are mobile terminals.

3. The method of claim I wherein the transmitting the request further comprises transmitting an interrupt request.

4. The method of claim 1 wherein the transmitting a response further comprises transmitting an interrupt response.

5. The method of claim 1 wherein the transmitting an authorization further comprises sending a confirmation of the interrupt request.

6. A method of performing a transition from a facsimile session to a voice session during a single call between a mobile terminal and a facsimile machine, the method comprising:
requesting a session interrupt,
receiving a response to the session interrupt request,
sending a confirmation of the session interrupt request, and
negotiating to the voice session.

7. A method of claim 6 further comprising:
receiving a request procedure interrupt signal,
sending a procedure interrupt request signal to interrupt the facsimile session upon receipt of the request procedure interrupt signal,
receiving a procedure interrupt response signal,
sending a transition to voice signal to the mobile terminal upon receipt of the procedure interrupt response signal,
receiving a cellular voice request signal, and
sending procedure interrupt confirmation signal upon receipt of the cellular voice request signal.

8. The method of claim 7 wherein the request procedure interrupt signal is selected from the group consisting of a <DLE><pri> signal, a AT+FPS signal, and a +FDR signal.

9. The method of claim 7 wherein the procedure interrupt request signal is selected from the group consisting of a PRI-Q signal, a PIP signal, and a PIN signal.

10. The method of claim 7 wherein the procedure interrupt response signal is selected from the group consisting of a PIP signal, a PIN signal, and a PRI-Q signal.

11. The method of claim 7 wherein the transition to voice signal is a +FVO signal.

12. The method of claim 7 wherein the cellular voice request signal is an <EM><Voice Request> signal.

13. The method of claim 7 wherein the procedure interrupt confirmation signal is a PRI-Q signal, a PIP signal, and a PIN signal.

14. A method of claim 6 further comprising:
receiving a procedure interrupt request signal,
sending a transition to voice signal to interrupt the facsimile session upon receipt of the procedure interrupt signal,
receiving a cellular voice request signal,
sending a procedure interrupt response upon receipt of the cellular voice request signal, and
receiving a procedure interrupt confirmation.

15. The method of claim 14 wherein the procedure interrupt request signal is selected from the group consisting of a PIP signal, a PIN signal, and a PRI-Q signal.

16. The method of claim 14 wherein the transition to voice signal is a +FVO signal.

17. The method of claim 14 wherein the cellular voice request signal is an <EM><Voice Request> signal.

18. The method of claim 14 wherein the procedure interrupt response signal is selected from the group consisting of a PRI-Q signal, a PIP signal, and a PIN signal.

19. The method of claim 14 wherein the procedure interrupt confirmation signal is selected from the group consisting of a PIP signal, a PIN signal, and a PRI-Q signal.

20. A telecommunications system, comprising:
a base station adapted to communicate with a mobile terminal, wherein the mobile terminal is capable of sending data used by fax applications,
a mobile switching center in communication with the base station for causing the base station to communicate with the mobile terminal,
a inter-working function unit coupled to the mobile switching center and in communication with a fax terminal through a PSTN,
wherein the inter-working function unit comprises:
a means for receiving a request procedure interrupt signal,
a means for sending a procedure interrupt request signal to interrupt the facsimile session upon receipt of the request procedure interrupt signal,
a means for receiving a procedure interrupt response signal,
a means for sending a transition to voice signal to the mobile terminal upon receipt of the procedure interrupt response signal,
a means for receiving a cellular voice request signal, and
a means for sending procedure interrupt confirmation signal upon receipt of the cellular voice request signal.

21. A telecommunications system, comprising:
a base station adapted to communicate with a mobile terminal, wherein the mobile terminal is capable for sending data used by fax applications,
a mobile switching center in communication with the base station for causing the base station to communicate with the mobile terminal,
a inter-working function unit coupled to the mobile switching center and in communication with a fax terminal through a PSTN,
wherein the inter-working function unit comprises:
a means for receiving a procedure interrupt request signal,
a means for sending a transition to voice signal to interrupt the facsimile session upon receipt of the procedure interrupt signal,
a means for receiving a cellular voice request signal,
a means for sending a procedure interrupt response upon receipt of the cellular voice request signal, and
a means for receiving a procedure interrupt confirmation.
